(19) United States
(12) Patent Application Publication
(10) Pub. No.: US 2024/0077685 A1
(43) Pub. Date: Mar. 7, 2024

(54) SHUFFLE CABLE

(71) Applicant: CommScope Technologies LLC, Hickory, NC (US)

(72) Inventors: Dennis Ray WELLS, Richfield, MN (US); John Paul ANDERSON, Eden Prairie, MN (US); Damon F. DEBENEDICTIS, Castle Rock, CO (US); Joseph J. LICHTENWALNER, Newton, NC (US)

(21) Appl. No.: 18/507,883

(22) Filed: Nov. 13, 2023

Related U.S. Application Data
(63) Continuation of application No. PCT/US2022/028529, filed on May 10, 2022.
(60) Provisional application No. 63/188,044, filed on May 13, 2021.
(60) Provisional application No. 63/305,507, filed on Feb. 1, 2022.
(60) Provisional application No. 63/307,482, filed on Feb. 7, 2022.

(51) Int. Cl. G02B 6/38; G02B 6/44

(52) U.S. Cl. CPC G02B 6/3885; G02B 6/3851; G02B 6/44715; G02B 6/3825

(57) ABSTRACT

A shuffle cable provides optical fibers in color-coded groups to facilitate the break-out of optical fibers into standard multi-color, multi-signal ribbon cables within the context of spine-leaf cabling.

### CROSS-REFERENCE TO RELATED APPLICATIONS

This application is a Continuation of International Patent Application No. PCT/US2022/028529 filed on May 10, 2022, which claims the benefit of U.S. Patent Application Ser. No. 63/188,044, filed on May 13, 2021, claims the benefit of U.S. Patent Application Ser. No. 63/305,507, filed on Feb. 1, 2022 and claims the benefit of U.S. Patent Application Ser. No. 63/307,482, filed on Feb. 7, 2022, the disclosures of which are incorporated herein by reference in their entireties.

### FIELD

The present disclosure is directed to spine-leaf fabrics and, more particularly, to a shuffle cable for spine-leaf fabrics.

### BACKGROUND

Multi-stage switching networks, e.g., spine-leaf fabrics, enable the distributed computing that support today's e-commerce, social media and cloud-based applications. The architecture of a spine and leaf fabric provides for one or more spine switches and a plurality of leaf switches. Each leaf switch is connected to each spine switch within the fabric to provide redundancy and equal latency in data transmissions. The nature of a spine and leaf architecture gives rise to significant amounts of fiber optical cabling and concerns associated with fiber optic cabling including managing the quantity of cables/optical fibers and ensuring an optical fiber is coupled to the correct subsequent optical fiber to establish a desired transmission path.

### SUMMARY

A shuffle cable of the present disclosure provides optical fibers in color-coded groups to facilitate the break-out of optical fibers into multi-color, multi-signal ribbon cables within the context of spine-leaf cabling.

In certain aspects the present disclosure is directed to a shuffle cable having N number of ribbonized groups of optical fibers with of the N number of groups having M number of optical fibers. Each of the N number of groups is color-coded with a distinct color to distinguish it from all other of the N number of groups of optical fibers.

In certain aspects, N is equal to M. In certain aspects, the N number of groups are color-coded according to a pre-determined color sequence. In certain aspects the pre-determined sequence corresponds to a standard established by the Telecommunication Industry Association (TIA) comprising TIA-598 or TIA-598-C.

In certain aspects, the shuffle cable has a first end and a second end. Further, at least one of the first and second ends of each of the N number of ribbonized groups of optical fibers is pre-terminated to a respective connector. In certain aspects each of the N number of ribbonized groups of optical fibers at the first end is pre-terminated to a respective connector and each of the N number of ribbonized groups of optical fibers at the second end is connector-free.

In certain aspects, at least one of the optical fibers of each of the N number of groups of optical fibers includes an indicator of a numerical sequence of the at least one optical fiber within its respective group of optical fibers. In certain aspects, the M number optical fibers within each group are marked with at least a first fiber indicator and a last fiber indicator, the first and last fiber indicators indicating a numerical sequence of the M number of fibers in the group.

In certain aspects, the present disclosure is directed to a method of breaking-out an N number of leaf cables in a spine-leaf fabric. The method includes coupling each leaf cable having M-number of optical fibers carrying a redundant signal to one of N number of color-coded groups of a first end of a shuffle cable; each color-coded group having N number of ribbonized optical fibers and each color-coded group having a color to distinguish it from all others of the N number of groups. The method further includes, at a second end of the shuffle cable, establishing N number of multi-color, multi-signal cable configurations by pulling one optical fiber from each of the N number of color-coded groups of N number of ribbonized optical fibers and connectorizing the N number of multi-color optical fibers at one of N number of connectors.

### BRIEF DESCRIPTION OF THE DRAWINGS

FIG. 1 is an example of a prior art optical fiber spine and leaf fabric utilizing a patch panel to break-out optical fibers from a plurality of leaf switches for connection to a spine switch.

FIG. 2 is an example of a spine and leaf fabric utilizing a shuffle cable according to the present disclosure.

FIG. 3 illustrates a standard ribbon cable and a shuffle cable of the present disclosure.

FIG. 4 illustrates a break-out of a shuffle cable of the present disclosure.

FIG. 5 is detailed view of an end of one of the color-coded groupings of optical fibers of the shuffle cable of FIG. 4 with fiber indicators.

FIG. 6 is detailed view of an end of one of the color-coded groupings of optical fibers of the shuffle cable of FIG. 4 with alternative fiber indicators.

FIGS. 7A-7E provide an example of a color coding chart and fiber indicators for a shuffle cable having 288 fibers maintained in 24 solid color groupings of 12 optical fibers, respectively.

FIG. 8 illustrates an example of a transition housing usable with the shuffle cable.

FIG. 9 illustrates an example of a connectorized 288 fiber shuffle cable.

### DETAILED DESCRIPTION

A shuffle cable of the present disclosure provides optical fibers in color-coded groups to facilitate the break-out of optical fibers into multi-color, multi-signal ribbon cables within the context of spine-leaf cabling. Each color-coded group of the shuffle cable is connectorized at a first end to interface with a redundant signal cable from a leaf switch. A second end of the shuffle cable is initially left connector-free facilitating the pull of a single fiber from each color group to form multi-color, multi-signal ribbon cables; each multi-color, multi-signal ribbon cable comprised of one optical fiber from each of the color-coded groups of optical fiber. The formed multi-color, multi-signal ribbon cable can then be connectorized for connection to a spine switch.

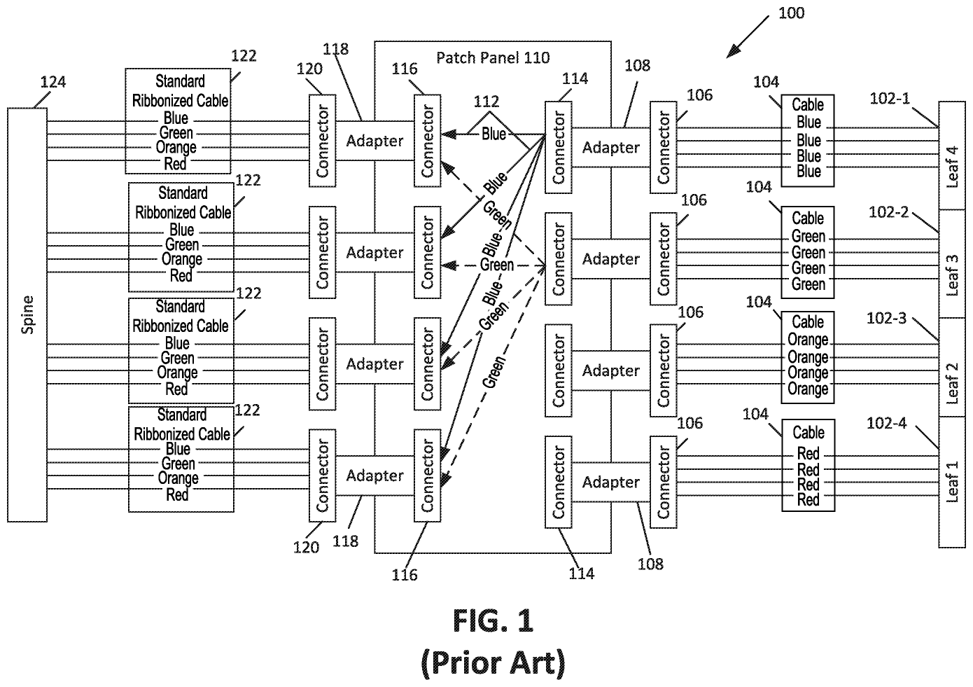

Referring to FIG. 1, a simplified example of a common spine-leaf configuration 100 is illustrated. As shown, the configuration 100 includes four leaf switches 102 (e.g., 102-1, 102-2, 102-3 and 102-4). In the configuration shown, each of the leaf switches 102 transmits a redundant signal (e.g., the same signal) over four optical fibers of a respective leaf cable 104 having an end terminated with a connector 106 to interface with a respective adapter 108 that is mounted in a patch panel 110; a patch panel 110 is typically located in a cabinet (not shown).

Break-out optical fibers 112 are coupled between connectors 114 and 116 at the patch panel 110 and serve to distribute one of the four redundant signals at one of the connectors 114 to each of the four connectors 116. The break-out from only two of the connectors 114 (e.g., Blue and Green) is shown for clarity. The signals of the break-out optical fibers 112 are passed through respective adapters 118 to the connector 120 of a standard ribbonized cable 122 that is multi-colored (e.g., reflective of the colors of each of the different leaf cables 104—Blue, Green, Orange and Red) and transmitting signals from each of the four leaf switches 102-1, 102-2, 102-3, 102-4. The standard ribbonized cable 122 is communicatively coupled to a spine 124 The break-out of signals in the configuration 100 requires for each leaf cable 104: (a) four connectors (e.g. connectors 106, 114, 116, 120); (b) two adapters (e.g., 108, 118); (c) break-out optical fibers 112; (d) a patch panel 110; and (e) a cabinet in which to place the patch panel (not shown).

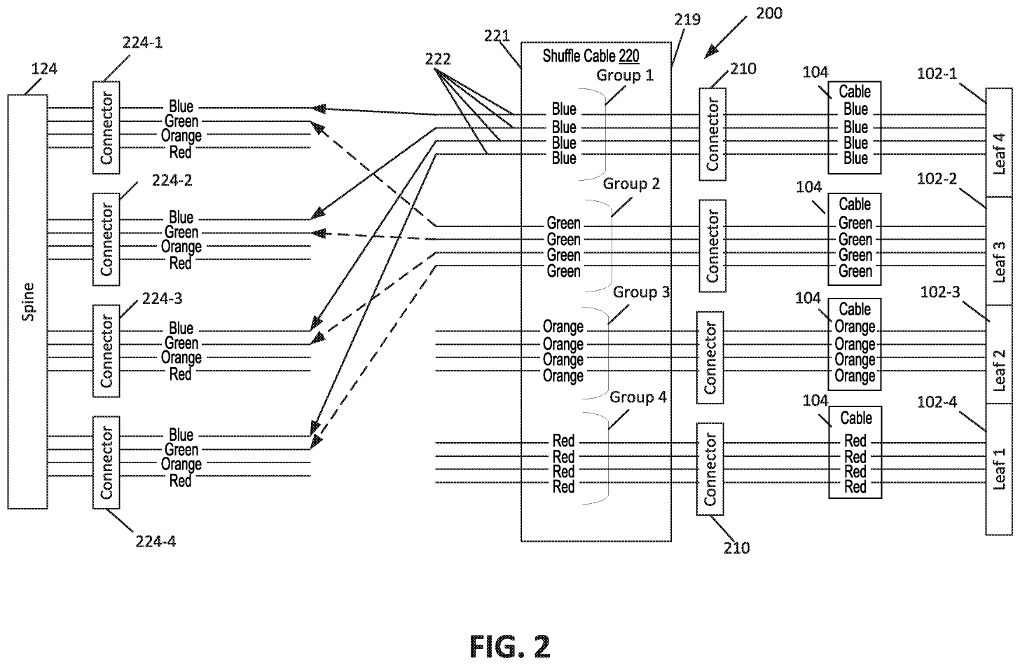

In contrast, the shuffle cable of the present disclosure replaces items (a)-(e) for each leaf cable 104 with a single cable configuration and two connectors as illustrated in FIGS. 2-5. In doing so, the shuffle cable reduces signal loss, decreases the cost of installation and reduces the amount of floor space needed to establish a spine-leaf fabric.

Referring to FIG. 2, a simplified example of a spine-leaf configuration 200 is illustrated and includes a shuffle cable 220 having a first end 219 and a second end 221. As shown, the configuration 200 includes the four leaf switches 102-1, 102-2, 102-3 and 102-4, each of which transmits a redundant signal over four optical fibers of a respective leaf cable 104. The leaf cable 104, having an MPO connector (not shown), is terminated at a pre-terminated first end connector 210 (e.g., MPO connector) of the shuffle cable 220. While a pre-terminated first end 219 of the shuffle cable is preferred, it is also possible for the shuffle cable 220 to have a configuration wherein the first end 219 is connector free, e.g. not pre-terminated with a connector.

Extending from the respective pre-terminated first end connectors 210, the shuffle cable 220 includes respective ribbonized groups of color-coded optical fibers—in this instance four ribbonized groups with each group having four optical fibers 222. For example, the first group is color-coded blue, the second is color-coded green, the third is color-coded orange, and the fourth is color-coded red. The optical fiber group color coding in this instance is random, however, in certain embodiments, the optical fiber group color coding corresponds to known color-coding standards and sequences such as a Telecommunications Industry Association (TIA) standard, e.g., TIA-598 or TIA-598-C. The color-coding of each group is achieved via a ribbonized jacket about the optical fibers 222 of the respective group.

The second end 221 of the shuffle cable 220 is presented in a connector-free configuration. The connector-free second end 221 enables an installer to separate an individual optical fiber 222 from each respective color-coded group and terminate the combined multi-color optical fibers 222 at a respective second connector 224 (e.g., an MPO connector) in a multi-color, multi-signal cable configuration. For example, the first blue optical fiber from the first color-coded group is placed in the first position at the first of the second connectors 224-1, the second blue optical fiber is placed in the first position of the second of the second connectors 224-2, the third blue optical fiber is placed in the first position of the third of the second connector 224-3 and the fourth blue optical fiber is placed in the first position of the fourth of the second connectors 224-4. Similarly, the first green optical fiber of the second group is placed in the second position of the first of the second connectors 224-1, the second green optical fiber of the second group is placed in the second position of the second of the second connectors 224-2, the third green optical fiber of the second group is placed in the second position of the third of the second connectors 224-3 and the fourth green optical fiber of the second group is placed in the second position of the fourth of the second connectors 224-4. The third and fourth groups of color-coded optical fibers are terminated similarly. The respective second connectors 224 may then be communicatively coupled directly to the spine 126.

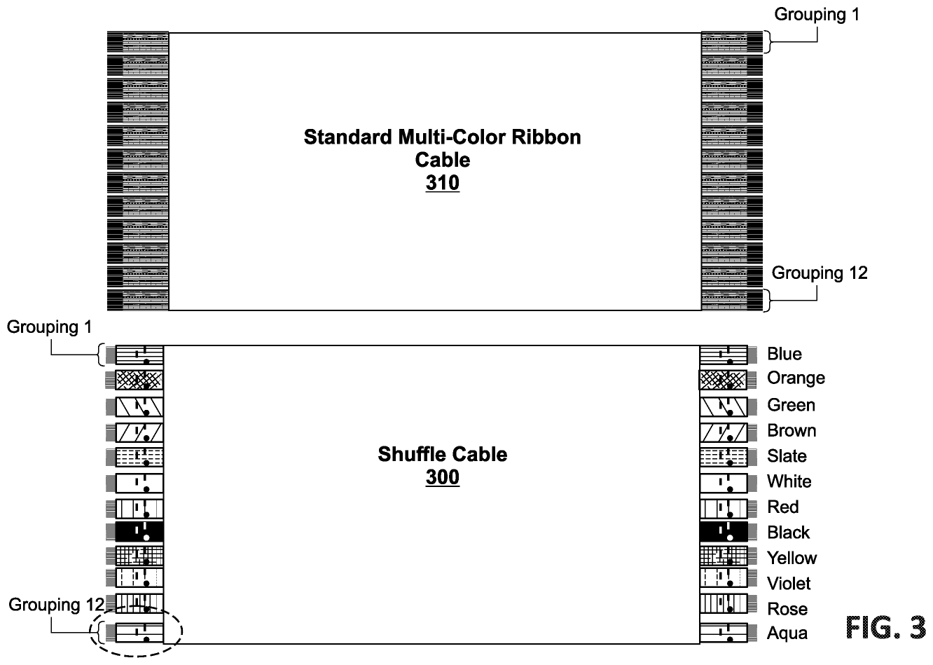

Referring now to FIG. 3, the difference between a shuffle cable 310 and a standard multi-color ribbon cable 310 can be appreciated. In the illustrated example, each of the cables 300 and 310 is a ribbonized cable having 12 groupings with each group having 12 optical fibers. With the standard multi-color ribbon cable 310, each individual optical fiber of a grouping is color-coded distinctly from the color-coding applied to the other 11 optical fibers of the group. For example, each group of the standard multi-color ribbon cable 300 has 12 optical fibers having a fiber order color of blue, orange, green, brown, slate, white, red, black, yellow, violet, rose and aqua. In contrast, the shuffle cable 300 has 12 groupings but each fiber of the group is color-coded the same color as the other optical fibers within its group. As such, the groups themselves, rather than the individual optical fibers, are presented in the fiber order color of blue, orange, green, brown, slate, white, red, black, yellow, violet, rose and aqua.

The shuffle cable of the present disclosure has been illustrated as a shuffle cable 220 of four groupings of four optical fibers in FIG. 2 and as a shuffle cable 300 of 12 groupings of 12 optical fibers in FIG. 3. However, it is possible to configure the shuffle cable in any configuration where an N number of optical fiber groupings is equivalent to the N number of optical fibers contained within the grouping and each grouping of optical fibers is identified with one of N number of distinct colors. A shuffle cable of this configuration presents a first end that can be pre-terminated for interfacing with a leaf cable and second free end enabling break-out to N number of multi-color, multi-signal cable configurations that can be connectorized subsequent the break-out for interfacing with a spine switch.

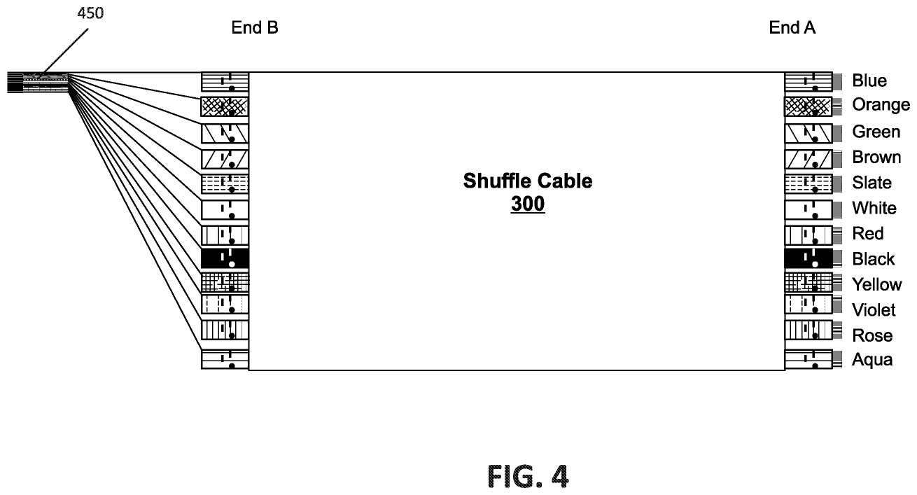

The break-out for one of twelve multi-color, multi-signal cable configurations 450 from the shuffle cable 300 of FIG. 3 is illustrated in FIG. 4. The break-out is performed by separating (e.g., pulling the optical fiber apart from the remaining optical fibers in the ribbonized color-coded group) a first optical fiber from each of the color-coded groups and terminating the first optical fibers from all color-coded groupings together at a connector to form a multi-color, multi-signal cable configuration. Second optical fibers from each color-coded groupings are terminated at a second connector, third optical fibers from each color-coded grouping are terminated at a third connector and so on until all twelve multi-color, multi-signal cable configurations 450 are established and connectorized. The multi-color color-coding sequence of the fibers of each of the twelve multi-color, multi-signal cable configurations 450 corresponds to the color-coding sequence of the groups of fibers of the shuffle cable 300.

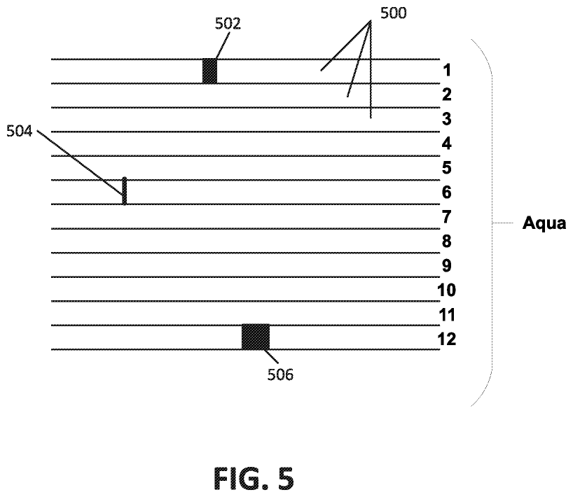

Referring to FIG. 5, a detailed view of the end of the aqua fiber grouping of FIG. 3 is illustrated. As shown, the aqua fiber grouping generally includes two or more optical fibers and, in this example, includes 12 optical fibers 500. Jackets of the optical fiber grouping are not only color-coded but are marked with one or more unique indicators to provide an installer with an indication of the numerical order of the optical fibers for assistance in establishing the multi-color, multi-signal cable configurations 450 (see FIG. 4). In the example of FIG. 5, the end of the aqua fiber grouping is provided with a first fiber indicator 502, a sixth (or middle) fiber indicator 504, and a twelfth fiber (or last fiber) indicator 506. In certain embodiments only the first fiber is marked with an indicator. In certain embodiments only the last fiber is marked with an indicator. In certain embodiments, only the middle fiber is marched with an indicator. In certain embodiments, only the first and last fibers are marked with an indicator. In certain embodiments, each optical fiber is marked with an indicator, for example, each optical fiber may be marked with a numerical indicator (e.g., 1-12). In certain embodiments, every other optical fiber is marked with an indicator. The indicators are particularly useful in high fiber count shuffle cables, e.g. a shuffle cable with 144 fibers (e.g., twelve color-coded groups with twelve optical fiber in each group) to ensure that the Nth optical fiber of each of the N groups is routed to the Nth connector to establish the N number of multi-color, multi-signal cable configurations 450.

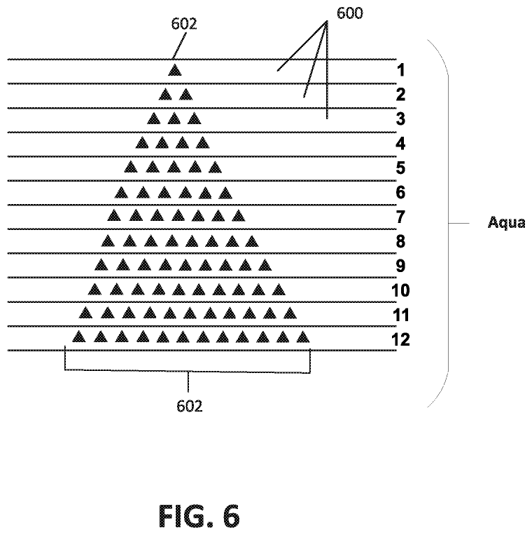

Referring to FIG. 6, a detailed view of the end of the aqua fiber grouping of FIG. 3 is illustrated. As shown, the aqua fiber grouping generally includes two or more optical fibers and, in this example, includes 12 optical fibers 600. Jackets of the optical fiber grouping are not only color-coded but are marked with one or more unique indicators to provide an installer with an indication of the numerical order of the optical fibers for assistance in establishing the multi-color, multi-signal cable configurations 450 (see FIG. 4). In the example of FIG. 6, the end of the aqua fiber grouping is provided with a first fiber indicator 602 while an additional fiber indicator is added to each subsequent fiber with a twelfth fiber (or last fiber) including twelve fiber indicators indicator 602. In certain embodiments only the first fiber is marked with an indicator. In certain embodiments only the last fiber is marked with an indicator. In certain embodiments, only the middle fiber is marched with an indicator. In certain embodiments, only the first and last fibers are marked with an indicator. In certain embodiments, each optical fiber is marked with an indicator, for example, each optical fiber may be marked with a numerical indicator (e.g., 1-12). In certain embodiments, every other optical fiber is marked with an indicator. The indicators are particularly useful in high fiber count shuffle cables, e.g. a shuffle cable with 144 fibers (e.g., twelve color-coded groups with twelve optical fiber in each group) to ensure that the Nth optical fiber of each of the N groups is routed to the Nth connector to establish the N number of multi-color, multi-signal cable configurations 450.

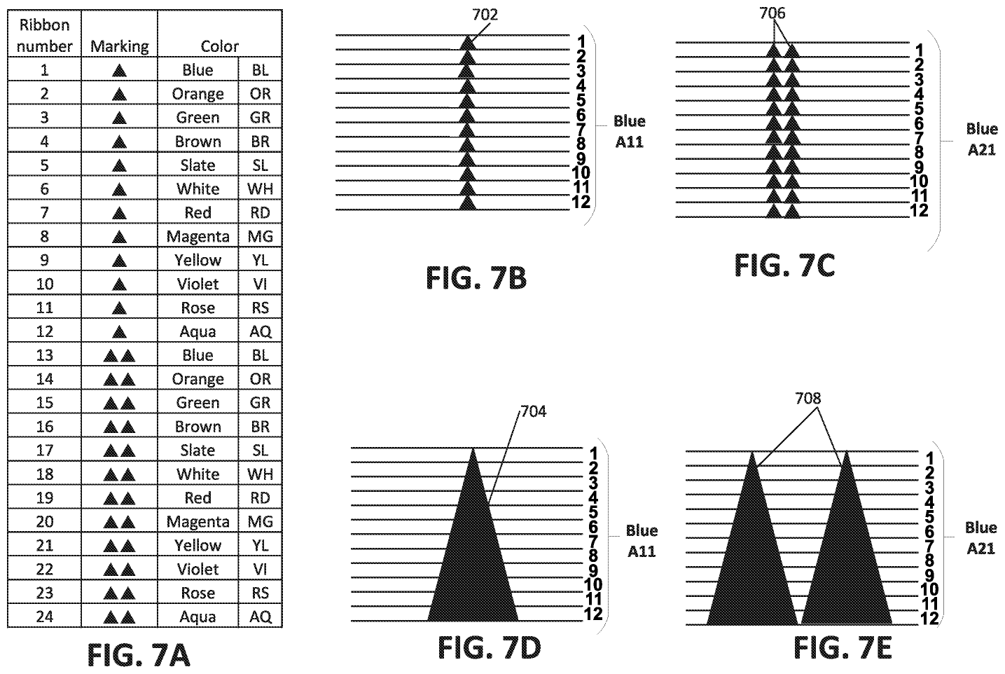

FIGS. 7A-7E illustrate additional examples of fiber color coding and fiber indicators. In the illustrated instance a shuffle cable as described herein is configured as a 288 fiber shuffle cable with a first set of twelve ribbons (e.g., ribbons 1-12) with each ribbon having 12 fibers of the same color according to the color chart of FIG. 7A (note that the standard black fiber color has been replaced by magenta in order to enable a black indicator to be visible on the fiber) and marked with a first type of indicator (e.g., a single indicator 702 on each fiber as shown in FIG. 7B or a single indicator 704 printed across the twelve fibers of the ribbon as shown in FIG. 7D). The 288 fiber shuffle cable additionally includes a second set of twelve ribbons (e.g., ribbons 13-24) with each ribbon having 12 fibers of the same color according to the color chart of FIG. 7A (note that the standard black fiber color has again been replaced by magenta in order to enable a black indicator to be visible on the fiber) and marked with a second type of indicator (e.g., a double indicator 706 on each fiber as shown in FIG. 7C or a double indicator 708 printed across the twelve fibers of the ribbon as shown in FIG. 7E). In FIGS. 7D and 7E, the point/apex of the indicator 704, 708 is at the fiber 1 side while the flat portion of the indicator 704,708 is provided at the fiber 12 side of each ribbon. The shuffle cable can include any number of desired multiples (e.g., 1, 2, 3, 4, etc.) of 12 fiber groupings (144 total fibers), or other fiber groupings, such as 8 or 16 fiber groupings.

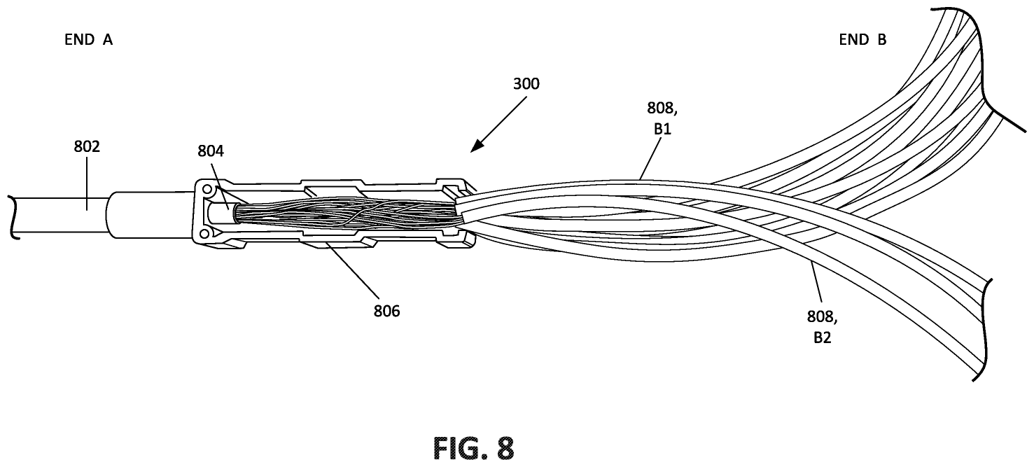

FIG. 8 provides an example of the shuffle cable 300 in use. The shuffle cable 300 is provided with an outer jacket 802 and a central tube 804 through which the solid color ribbonized fibers extend from End A of the cable 300. A transition housing 806 (without its cover) is slid down over the central tube 804 to reveal the solid color ribbonized fibers. The solid color ribbonized fibers are then sorted to the standard color order (e.g., blue through aqua). Once sorted, the first fiber is peeled off of each solid color ribbon in color coded order to establish a new grouping of multi-color fibers, (e.g., blue through aqua), then inserted through a furcation tube 808 at End B of the cable 300; the furcation tube is preferably labeled (e.g., “B1”) to identify it as the first of the multi-color groupings of fibers. This step is repeated by peeling off the second fibers of each solid color ribbon to create a new multi-color grouping that is furcated and labeled, and so on, until the last fiber from each of the solid color ribbons are joined in a multi-color group and furcated with a label, for example, of “B12”. The multi-color fibers extending from the end of the furcation tube 808 are then ribbonized in color coded order (e.g., blue through aqua) and connectorized, for example, with an MPO connector. The connector can be an 8 fiber, a 12 fiber, a 16 fiber, a 24 fiber connector (e.g., 2 rows times 12), or other number as desired.

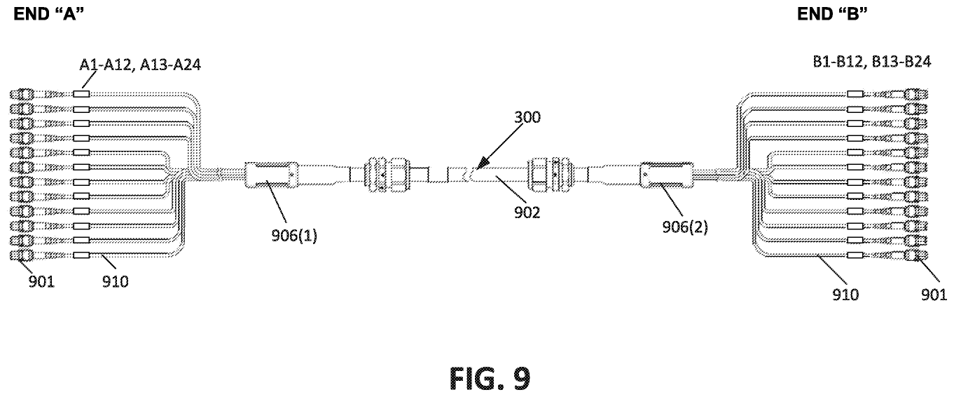

FIG. 9 illustrates an example of a connectorized 288 fiber shuffle cable 300 extending between a first transition housing 906(a) at END A of the fiber shuffle cable 300 and a second transition housing 906(b) at END B of the fiber shuffle cable 300; in this example fiber shuffle cable 300 includes a first set of twelve solid color ribbons with each ribbon having twelve fibers and a second set of twelve solid color ribbons with each ribbon having twelve fibers. The ribbons themselves are organized according to the color coding of FIG. 7A.

At END A of the fiber shuffle cable 300, each of 24 solid color ribbons are placed within a respective furcation tube 910 and the furcation tube 910 labeled A1-A24 in an order consistent with the color coding of FIG. 7A. The solid color ribbons are then connectorized with an MPO 901. In certain embodiments each solid color ribbon is connectorized with its own twelve fiber MPO 901 while in other embodiments the two same color, solid color ribbons (e.g., the two blue ribbons—ribbon 1 and ribbon 13) are commonly connectorized with a twenty-four fiber MPO 901. Note that in FIG. 9 only the top twelve furcation tubes 910 A1-A12 are visible with the bottom twelve furcation tubes 910 A13-A24 hidden beneath. In certain embodiments the top twelve ribbons are cut to the same length as the bottom twelve ribbons while in other embodiments the top twelve ribbons are cut to a different length (e.g., shorter or longer) than the bottom twelve ribbons.

At END B of the fiber shuffle cable 300, the solid color ribbons are positioned in color coded order, a first set of twelve multi-color groups of twelve fibers are created and a second set of twelve multi-color groups of twelve fibers are created with each of the multi-color groups having fibers organized to the color code of FIG. 7A and described with reference to FIG. 8. The multi-color groups are ribbonized in color coded order, placed in a respective labeled furcation tube 910 B1-B24 and connectorized with an MPO connector 910 (e.g., a 12 fiber or 24 fiber MPO connector). Note that in FIG. 9 only the top twelve furcation tubes 910 B1-B12 are visible with the bottom twelve furcation tubes 910 B13-B24 hidden beneath. In certain embodiments the top twelve multi-color ribbonized fibers are cut to the same length as the bottom twelve while in other embodiments the top twelve multi-color ribbonized fibers are cut to a different length (e.g., shorter or longer) than the bottom twelve.

More specifically, FIG. 9 relates to a product and a method of assembly where:
A shuffle trunk cable is constructed using an example 288-fiber cable with 24 twelve-fiber ribbons with a color and marking scheme. All individual fibers in each ribbon are the same color. The ribbons are colored blue, orange, green, etc. The first twelve ribbons are marked at intervals with a black dot matrix ▴. The second twelve ribbons are marked ▴▴. The point of the ▴ or ▴▴ is on the Fiber 1 side of each ribbon, the flat part of the ▴ or ▴▴ is on the Fiber 12 side of each ribbon. Since black markings cannot be seen on a black ribbon, the ribbon which would be black is magenta instead. The ribbon numbers, marking, and colors are as follows:

| | | |
|---|---|---|
| Ribbon number | Marking | Color |

| | | | |
|---|---|---|---|
| 1 | ▴ | Blue | BL |
| 2 | ▴ | Orange | OR |
| 3 | ▴ | Green | GR |
| 4 | ▴ | Brown | BR |
| 5 | ▴ | Slate | SL |
| 6 | ▴ | White | WH |
| 7 | ▴ | Red | RD |
| 8 | ▴ | Magenta | MG |
| 9 | ▴ | Yellow | YL |
| 10 | ▴ | Violet | VI |
| 11 | ▴ | Rose | RS |
| 12 | ▴ | Aqua | AQ |
| 13 | ▴▴ | Blue | BL |
| 14 | ▴▴ | Orange | OR |
| 15 | ▴▴ | Green | GR |
| 16 | ▴▴ | Brown | BR |
| 17 | ▴▴ | Slate | SL |
| 18 | ▴▴ | White | WH |
| 19 | ▴▴ | Red | RD |
| 20 | ▴▴ | Magenta | MG |
| 21 | ▴▴ | Yellow | YL |
| 22 | ▴▴ | Violet | VI |
| 23 | ▴▴ | Rose | RS |
| 24 | ▴▴ | Aqua | AQ |

### PROCESSING ON END B

### Cable Preparation

### Definition of Cable Prep Length:

“Cable prep length”=33″ (breakout length)+5″ (to expose rip cords)+4″ (to distinguish between fiber groups which will go through the same furcation tubing)+(extra for connectorization).

### Remove Outer Yellow Outer Jacket End Portion:

Ring cut the yellow outer jacket 5″ from the cut end, and at the “Cable prep length” (as defined above) from the cut end.

### Trim Inner White Tube to Length:

At the edge of the remaining yellow jacket, cut all materials which are between the yellow jacket and the white central tube (woven and rod strength members, fabric, and rip cords), and discard them. Slide the transition housing (without its cover) a short distance down the length of the white tube. Ring cut the white tube 1.177″ (1-11/64″) from the yellow jacket. Leaving the transition housing over the fiber ribbons, slide the cut white tube out from under the transition housing and off the assembly, and discard it.

### Cut Ribbons 1-12 Shorter:

Cut Ribbons 1-12 (ribbons marked ▴) 4″ shorter than Ribbons 13-24 (ribbons marked ▴▴). Later this will allow separation of fibers which should go on Row A of an MPO24 from fibers which should go on Row B.

### Sort Ribbons

Select a method of holding each ribbon so that the order of the remaining fibers can be maintained as individual fibers are peeled off the ribbon. Possible options:
   A fixture or clamp for each ribbon which will maintain the order of the remaining fibers;
   Tape ribbons down to maintain the order of the remaining fibers.
Untangle and/or separate the ribbons down to where they exit the white tube inside the transition housing. Then sort the ribbons and, using the method of holding chosen above, arrange the ribbons in order from (blue ▴) Ribbon 1 through (aqua ▴) Ribbon 12, and (blue ▴▴) Ribbon 13 through (aqua ▴▴) Ribbon 24.

### Fibers 1

### Ribbons 1-12:

Peel Fiber 1 off (blue ▴) Ribbon 1 to as close to the white tube as possible without bending. Removing the rollable ribbon matrix dots is not necessary. In a similar manner, peel Fiber 1 off (orange ▴) Ribbon 2 down to the white tube. Peel Fiber 1 off (green ▴) Ribbon 3 down to the white tube. Continue like this up through Fiber 1 of (aqua ▴) Ribbon 12. Push this group of 12 loose fibers, color coded blue through aqua (except magenta replacing black) through a new 33″ length of 3.6 mm furcation tubing.

### Ribbons 13-24:

Peel Fiber 1 off (blue ▴▴) Ribbon 13. Peel Fiber 1 off (orange ▴▴) Ribbon 14. Peel Fiber 1 off (green ▴▴) Ribbon 15. Continue like this up through Fiber 1 of (aqua ▴▴) Ribbon 24. Push this group of 12 loose fibers, also color coded blue through aqua (except magenta replacing black), through the same furcation tube containing the previous group of fibers from Ribbons 1-12.
Mark the furcation tube “B1”.
There should be two distinct groups of fibers coming out the end of the furcation tube, one group approximately 4″ longer than the other.

### Fibers 2:

Repeat the entire “Fibers 1” step, except:
   Peel Fiber 2 off the ribbons.
   Mark the furcation tube “B2”.

### Fibers 3:

Repeat the entire “Fibers 1” step, except:
   Peel Fiber 3 off the ribbons.
   Mark the furcation tube “B3”.
      . . . etc . . .

### Fibers 12:

Repeat the entire “Fibers 1” step, except:
   Use the remaining fibers, which should all be Fibers 12.
   Mark the furcation tube “B12”.

### Connectorize End B

For each furcation tube, separate the fibers coming out the end into two groups of 12, one shorter and one longer. Each group should be color coded blue through aqua (except magenta replacing black). Ribbonize each group separately, blue through aqua (except magenta replacing black). While maintaining one ribbon being shorter than the other, the ribbons may now be trimmed to a relative length that is more desirable to Operations. Connectorize the ribbons and furcation tube using an MPO24. With the ferrule window up, the shorter color coded ribbon should go into the top row of ferrule holes, and the longer color coded ribbon should go into the bottom row of ferrule holes.

End A of the shuffle cable can be broken out with furcation tubes and connectorized as shown in FIG. 9. End A can also be spliced to another trunk cable. End A can also be spliced to breakout cables.

The shuffle cable of the various examples is a jacketed cable, that contains a desired number of like colored fiber groupings. The shuffle cable is significantly longer than the disclosed breakouts or fanouts including the furcation tubes. In some cases, the jacketed shuffle cable is at least 10 times as long as the breakouts, at least 20 times, at least 50 times, or at least 100 times as long.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. Note that features of one or more embodiments can be incorporated in other embodiments without departing from the spirit of the invention. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed:

1. A shuffle cable comprising:
a cable having N number of ribbonized groups of optical fibers with each of the N number of groups having M number of optical fibers,
wherein each of the N number of groups is color-coded with a distinct color to distinguish it from all others of the N number of groups.

2. The shuffle cable of claim 1, wherein the N number of groups are color-coded according to a pre-determined sequence.

3. The shuffle cable of claim 2, wherein the pre-determined sequence is the sequence established under a Telecommunications Industry Association (TIA) standard comprising TIA-598 or TIA-598-C.

4. The shuffle cable of claim 1, wherein the shuffle cable has a first end and a second end and wherein each of the N number of ribbonized groups of optical fibers of at least one of the first and second ends is pre-terminated to a respective connector.

5. The shuffle cable of claim 1, wherein the shuffle cable has a first end and a second end and wherein each of the N number of ribbonized groups of optical fibers at the first end is pre-terminated to a respective connector and wherein each of the N number of ribbonized groups of optical fibers at the second end is connector-free.

6. The shuffle cable of claim 1, wherein at least one of the optical fibers of each of the N number of groups includes an indicator of a numerical sequence of the at least one optical fiber within its respective group.

7. The shuffle cable of claim 1, wherein the M number optical fibers within each group are marked with at least a first fiber indicator and a last fiber indicator, the first and last fiber indicators indicating a numerical sequence of the M number of fibers in the group.

8. A method of breaking-out an N number of leaf cables in a spine-leaf fabric, the method comprising:
coupling each leaf cable having M number of optical fibers carrying a redundant signal to one of N number of color-coded groups of a first end of a shuffle cable, each color-coded group having M number of ribbonized optical fibers and each color-coded group having a color to distinguish it from all others of the N number of color-coded groups; and
at a second end of the shuffle cable, establishing N number of multi-color, multi-signal cable configurations by pulling one optical fiber from each of the N number of color-coded groups of M number of ribbonized optical fibers and connectorizing the M number of multi-color optical fibers at one of N number of connectors.

9. The method of claim 8, wherein the N number of color-coded groups and the N number of connectors are color-coded according to a predetermined sequence.

10. The method of claim 9, wherein the pre-determined sequence is the sequence established under a Telecommunications Industry Association (TIA) standard comprising TIA-598 or TIA-598-C.

11. The method of claim 8, wherein each of the N number of ribbonized groups of optical fibers at the first end of the shuffle cable is pre-terminated to a respective first end connector.

12. The method of claim 8, wherein at least one of the optical fibers of each of the N number of groups includes an indicator of a numerical sequence of the at least one optical fiber within its respective group.

13. The method of claim 8, wherein the M number optical fibers within each group are marked with at least a first fiber indicator and a last fiber indicator, the first and last fiber indicators indicating a numerical sequence of the M number of fibers in the group.

14. A method of connecting a plurality of leaf switches to a spine switch in a spine and leaf fabric, the method comprising:
coupling a first end of a leaf cable to each of the plurality of leaf switches, each leaf cable having M number of optical fibers carrying a redundant signal;
coupling a second end of each of the leaf cables to one of N number of color-coded groups of a first end of a shuffle cable, each color-coded group having M number of ribbonized optical fibers and each color-coded group having a color to distinguish it from all others of the N number of groups;
at a second end of the shuffle cable, establishing N number of multi-color, multi-signal cable configurations by pulling one optical fiber from each of the N number of color-coded groups of M number of ribbonized optical fibers and connectorizing the M number of multi-color optical fibers at one of N number of connectors; and
coupling the connectorized N number of multi-color-multi-signal cable configurations to the spine switch.

15. The method of claim 14, wherein the N number of color-coded groups and the N number of connectors are color-coded according to a predetermined sequence.

16. The method of claim 15, wherein the pre-determined sequence is the sequence established under a Telecommunications Industry Association (TIA) standard comprising TIA-598 or TIA-598-C.

17. The method of claim 14, wherein each of the N number of ribbonized groups of optical fibers at the first end of the shuffle cable is pre-terminated to a respective first end connector.

18. The method of claim 14, wherein at least one of the optical fibers of each of the N number of groups includes an indicator of a numerical sequence of the at least one optical fiber within its respective group.

19. The method of claim 14, wherein the N number optical fibers within each group are marked with at least a first fiber indicator and a last fiber indicator, the first and last fiber indicators indicating a numerical sequence of the M number of fibers in the group.

20. The shuffle cable of claim 1, wherein N is equal to M.
